(19) United States
(12) Patent Application Publication
(10) Pub. No.: US 2002/0055293 A1
(43) Pub. Date: May 9, 2002

(54) PCI DRIVE MOUNTING

(76) Inventors: TRACY D. HARMER, ERIE, CO (US); CURTIS H. BRUNER, NIWOT, CO (US)

Correspondence Address: TEXAS INSTRUMENTS INCORPORATED, P O BOX 655474, M/S 3999, DALLAS, TX, 75265

(21) Appl. No.: 09/302,106

(22) Filed: Apr. 29, 1999

(51) Int. Cl. H01R 4/38; H01R 13/648

(52) U.S. Cl. 439/382

(57) ABSTRACT

An apparatus for connecting a peripheral device to a host computer including an assembly for mounting the peripheral device, a connection device for connecting the assembly to said host computer, and a shock-absorbing material to be positioned between the host computer and the assembly.

### FIELD OF THE INVENTION

The present invention relates to a housing and more particularly to a housing that contains a hard disk drive and a spindle motor to be connected to a host computer.

### BACKGROUND OF THE INVENTION

Rotating magnetic disk data storage devices or “hard disk drives” are an important part of computer systems.

These disk drives provide reliable permanent data storage along with rapid access to the data which is written on the magnetic disk. The hard disk drive (HDD) usually includes a transducer to produce a magnetic field to magnetize an area on the rotating disk and to sense a magnetic field from the magnetic area on the rotating disk. This magnetic area represents information that the user designated to have stored on the magnetic disk. This transducer usually is positioned at the end of an actuator arm which is moved by a voice coil motor. Typically, the hard disk drives are enclosed and may be mounted on a flexible printed circuit board to provide for connection to the electronics needed to control the reading and writing of data.

Hard disk drives are typically sensitive to movement and consequently must be rigidly attached to the computer system to avoid being subjected to excessive external loads or vibration. However, these hard disk drives should be removable from the computer.

The information that is stored on the hard disk drive is at time to time transferred between different computer systems. One solution to this problem is to load such information onto a floppy disk or to send such information over a phone line. However, such methods have inherent disadvantages. These disadvantages are magnified when the amount of data to be transferred is large.

Another problem is that there is a need to increase the memory available for use by the host computer. The problem is solved somewhat by plugging the hard disk drive into a slot of the host system.

Peripheral component interface (PCI) printed circuit cards were originally designed for use with personal computers. The micro computer market is massive and provides the incentive for the creation of extensive numbers of applications, many of which are implemented on PCI cards. The use of PCI cards offers an opportunity to utilize a developed industry standard packaging technology and a wide ranging set of applications. The use of PCI cards in a different environment offers opportunities, but can be complicated by new requirements not present in personal computer applications. PCI cards, in the normal environment, are installed when the device is shut down and the covers removed for card installation and removal.

FIG. 1 illustrates one such card of the prior art. In FIG. 1, a housing bracket 110 is connected to a printed circuit board 114 through connectors 112. Each of the connectors 112 is typically an integral part of housing bracket 110 and is coupled to the printed circuit board 114 through screws. The printed circuit board 114 may include a connector 100 for electrical connection to the host computer and for connection to the hard disk drive unit 116.

However, the connection apparatus illustrated in FIG. 1 suffers from a defect in that the hard disk drive unit 116 is subject to vibration due somewhat to the length and width of the hard disk drive unit 116. This movement results in vibration of the hard disk drive unit 116, and consequently the transducer positioned at the end of the actuator arm moves uncontrollably in response to this vibration. This uncontrolled movement is undesirable.

### SUMMARY OF THE INVENTION

The present invention includes an apparatus to rigidly hold the hard disk drive assembly (HDA) and reduce the uncontrollable vibration of the transducer.

The present invention uses a bracket which traverses the HDA and engages a shock-absorbing material which is positioned on the HDA.

The objects and advantages of the present invention are readily apparent to one of ordinary skill in the art after reviewing the following detailed description and the accompanying drawings.

### BRIEF DESCRIPTION OF THE DRAWINGS

FIG. 1 illustrates a printed circuit board connected to a host computer.

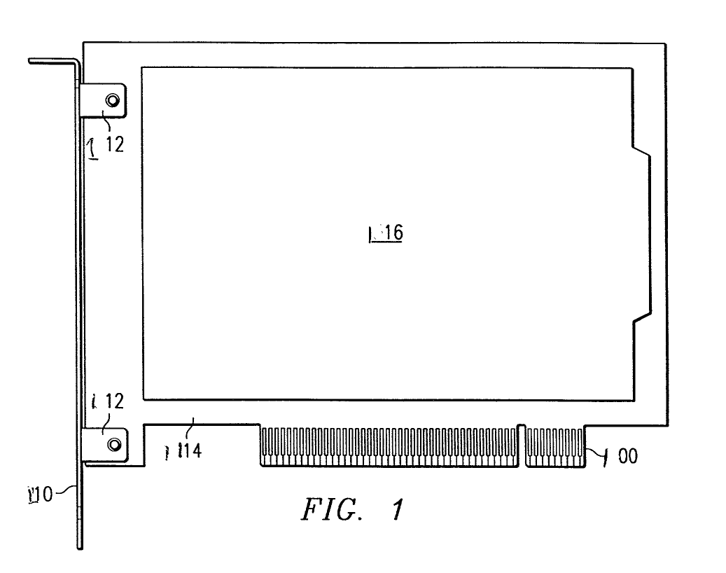

FIG. 2 illustrates a head-disk assembly.

FIG. 3 illustrates a side view of the present invention.

FIG. 4 illustrates a top view of the present invention.

### DETAILED DESCRIPTION OF THE PRESENT INVENTION

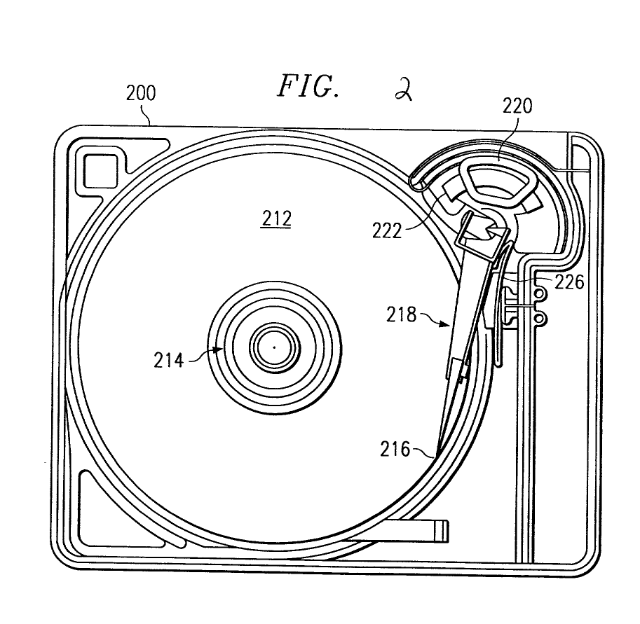

As illustrated in FIG. 2, the head-disk assembly for a peripheral device includes a magnetic disk 212 that is used to store data. The magnetic disk 212 is connected to a motor 214 which turns the magnetic disk 212 at a high rate of speed. The magnetic disk is read from and written to by a magnetic head 216 which is mounted on an actuator arm assembly 218. The actuator arm assembly 218 is moved by voice coil motor 220 that is connected to magnet 222.

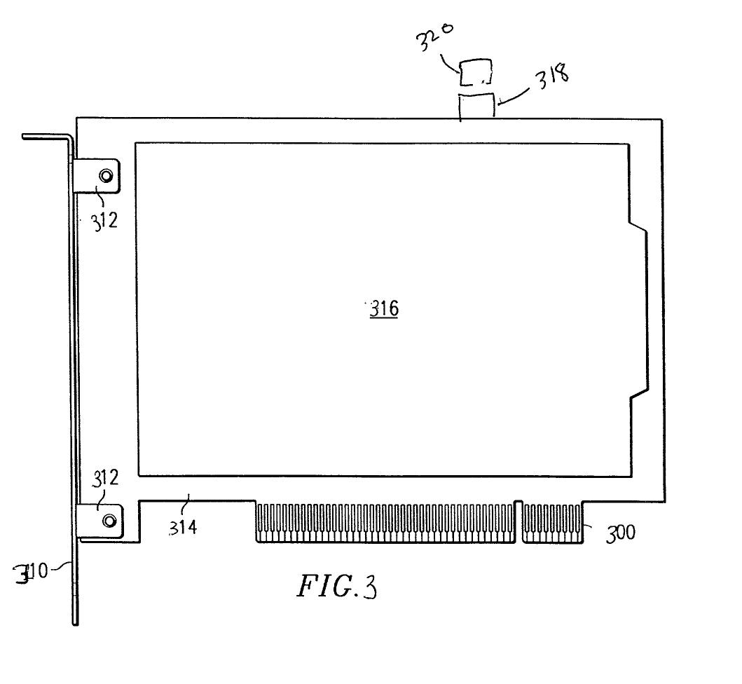

FIG. 3 illustrates a card which includes a printed circuit board 314 to serve as a base for the disk-head assembly 316. Although directions described are arbitrary because the card could be positioned in any direction, the connector 300 is directed downwards for connection to the host computer. The connector may be a PCI connector.

FIG. 3 illustrates that shock-absorbing apparatus 318 is mounted on printed circuit board 314. However, the shock-absorbing apparatus 318 may be directly mounted on the disk-head assembly 316. The shock-absorbing apparatus 318 is mounted opposite to connector 300. This positions the shock-absorbing material over the printed circuit 314. Other locations with respect to the disk-head assembly are possible. Any side could have the shock-absorbing apparatus 318 and may encompass the HDA. The shock-absorbing apparatus 318 could be positioned on the top, bottom, either side, or either end of the HDA. The shape of shock-absorbing material is illustrated in FIG. 3 as rectangular with dimensions necessary to dampen the vibration. Other shapes will work equally well. The shape of the shock-absorbing material 318 would be sufficient to cover the top surface of the printed circuit board 314. A traversing arm 320 traverses the printed circuit board 314 and engages the shock-absorbing material 318. By engaging the shock-absorbing material 318, the HDA assembly for the printed circuit board is not subject to vibration but is stabilized. As a further result, the moving parts of the head-disk assembly, such as the actuator arm assembly 218, is stable which results in better control. As a consequence, data can be more expediently read from the disk.

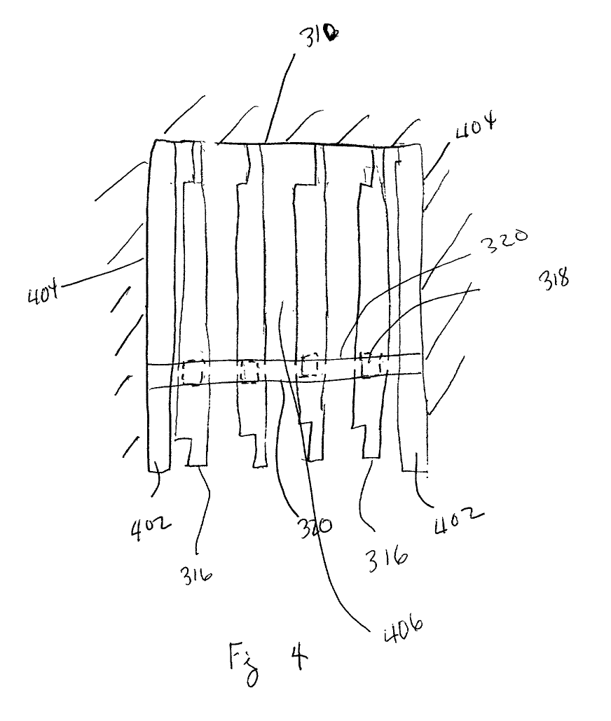

A top view of the present invention is illustrated in FIG. 4. A plurality of printed circuit boards 316 are mounted essentially perpendicular to traversing arm 320. The printed circuit boards 316 engage the traversing arm 320 through the shock-absorbing material 318. The traversing arm 320 and the shock-absorbing material 318 may be moved anywhere along the edge of printed circuit board 316. Additionally, shock-absorbing material 402 is mounted along the side of the cavity form 406 to receive the printed circuit boards 316. The shock-absorbing material 404 is to absorb the shock associated with movement of the printed circuit boards 316 if movement should occur. The shock-absorbing material 320 or the shock-absorbing material 402 could be made out of any appropriate material such as sponge, foam, etc.

1. An apparatus for connecting a peripheral device to a host computer; comprising:
an assembly for mounting said peripheral device;
a connection device for connecting said assembly to said host computer; and
a shock-absorbing material to be positioned between said host computer and said assembly.

2. An apparatus for connecting a peripheral device to a host computer, as in claim 1, wherein said apparatus further comprises a traversing arm to engage the shock-absorbing material.

3. An apparatus for connecting a peripheral device to a host computer, as in claim 1, wherein said shock-absorbing material is positioned adjacent to said assembly.

4. An apparatus for connecting a peripheral device to a host computer, as in claim 1, wherein said shock-absorbing material is positioned adjacent to and over said assembly.
